(19) United States
(12) Patent Application Publication
(10) Pub. No.: US 2009/0152746 A1
(43) Pub. Date: Jun. 18, 2009

(54) MULTI-STAGE INJECTION OVER-MOLDING SYSTEM WITH INTERMEDIATE SUPPORT AND METHOD OF USE

(75) Inventors: Dennis Ray Wells, Richfield, MN (US); James W. Conroy, Prior Lake, MN (US); Scott Carlson, Bloomington, MN (US); Keith Nelson, Brooklyn Center, MN (US); Gregory W. Kassekert, Woodbury, MN (US); Patrick Kuplic, Farmington, MN (US)

Correspondence Address: MERCHANT & GOULD PC, P.O. BOX 2903, MINNEAPOLIS, MN, 55402-0903, US

(73) Assignee: ADC Telecommunications, Inc., Eden Prairie, MN (US)

(21) Appl. No.: 12/252,874

(22) Filed: Oct. 16, 2008

Related U.S. Application Data
(60) Provisional application No. 60/980,384, filed on Oct. 16, 2007.

(51) Int. Cl. G02B 6/02; B29C 45/00

(52) U.S. Cl. 264/1.28; 425/588

(57) ABSTRACT

An over-molding tool is provided for over-molding an over-mold onto a fiber optic cable assembly. The over-molding tool includes first and second mold tool sets. The first mold tool set applies a first portion of the over-mold onto the fiber optic cable assembly. The second mold tool set then applies a second portion of the over-mold onto the fiber optic cable assembly. In preferred embodiments, the first and the second portions of the over-mold fuse to each other. By employing the first and the second mold tool sets, the fiber optic cable assembly can be supported at closer intervals along its length when being over-molded in comparison to a single, longer mold tool set. In addition, a lower capacity injection pump can be used when applying the over-mold in two portions. In other embodiments, additional mold tool sets can be added that sequentially apply additional portions of the over-mold.

### CROSS REFERENCE TO RELATED APPLICATION

The present application claims the benefit of U.S. Provisional Patent Application Ser. No. 60/980,384, filed Oct. 16, 2007, which application is hereby incorporated by reference in its entirety.

### TECHNICAL FIELD

The principles disclosed herein relate to molding systems. More particularly, the present disclosure relates to injection molding systems for applying over-molds to cables and to fiber optic cable systems. An example injection molding system is suitable for applying over-molds to fiber optic cable systems having main cables and branch cables.

### BACKGROUND

Optical networks are becoming prevalent in part because service providers want to deliver high bandwidth communication capabilities to customers. FIG. 7 illustrates a fiber optic network 100 deploying passive fiber optic lines. As shown at FIG. 7, the network 100 can include a central office 110 that connects a number of end subscribers 115 (also called end users 115 herein) in a network. The central office 110 can additionally connect to a larger network such as the Internet (not shown) and a public switched telephone network (PSTN). The network 100 can also include fiber distribution hubs (FDHs) 130 having one or more optical splitters (e.g., 1-to-8 splitters, 1-to-16 splitters, or 1-to-32 splitters) that generate a number of individual fibers that can lead to the premises of an end user 115. The various lines of the network can be aerial or housed within underground conduits (e.g., see conduit 105).

The portion of network 100 that is closest to central office 110 is generally referred to as the F1 region, where F1 is the “feeder fiber” or “feeder distribution cable” from the central office. The F1 portion of the network can include an F1 distribution cable having on the order of 12 to 48 feeder fibers; however, alternative implementations can include fewer or more fibers. The portion of network 100 near the end users 115 may be referred to as an F2 portion of network 100. Splitters used in an FDH 130 can accept fibers from an F1 distribution cable and can split those incoming fibers into, for example, 216 to 432 individual distribution fibers that can be associated with one or more F2 distribution cables. The F2 distribution cables are routed in fairly close proximity to the subscriber locations. Each fiber within the F2 distribution cable is adapted to correspond to a separate end user location.

Referring to FIG. 7, the network 100 includes a plurality of breakout locations 125 at which branch cables 144 (e.g., drop cables, stub cables, etc.) are separated out from main cables 120 (e.g., distribution cables). Breakout locations 125 can also be referred to as tap locations or branch locations and branch cables 144 can also be referred to as breakout cables 144. At a breakout location 125, fibers of the branch cables 144 are typically spliced to selected fibers of the main cable 120. However, for certain applications, the interface between the fibers of the main cable 120 and the fibers of the branch cables 144 can be connectorized.

Stub cables are typically branch cables 144 that are routed from breakout locations 125 to intermediate access locations 104 such as a pedestals, drop terminals or hubs. Intermediate access locations 104 can provide connector interfaces located between breakout locations 125 and subscriber locations 115. A drop cable is a cable that typically forms the last leg to a subscriber location 115. For example, drop cables are routed from intermediate access locations 104 to subscriber locations 115. Drop cables can also be routed directly from breakout locations 125 to subscriber locations 115 hereby bypassing any intermediate access locations.

Branch cables 144 can manually be separated out from a main cable 120 in the field using field splices. Field splices are typically housed within sealed splice enclosures. Manual splicing in the field is time consuming and expensive.

As an alternative to manual splicing in the field, pre-terminated cable systems have been developed. Pre-terminated cable systems include factory integrated breakout locations manufactured at predetermined positions along the length of a main cable (e.g., see U.S. Pat. Nos. 4,961,623; 5,125,060; and 5,210,812). The factory integrated breakout locations need to be sealed to prevent environmental contamination and degradation of the cable system. In addition, certain components of the cable system at the integrated breakout location need to be permanently secured in their respective positions. The present disclosure satisfies these and other needs.

### SUMMARY

Aspects of the present disclosure relate to manufacturing mid-span breakout configurations for pre-terminated fiber optic distribution cables. A molding system is disclosed that is particularly well suited for over-molding features onto slender and/or flexible objects such as fiber optic cables. The molding system can employ a mold with intermediate supports to hold the slender and/or flexible object(s) while over-molding to prevent unacceptable movement of and stresses within the object(s). The mold can further employ multiple cavities filled by a sequence of multiple injection cycles. The mold can be reconfigured between the injection cycles. In addition, the molding system can allow components to be placed on the slender and/or flexible object(s) prior to molding thus resulting in the components being embedded within the over-mold.

One aspect of the present disclosure relates to manufacturing a mid-span breakout configuration including over-molding an enclosure which provides reinforcement and environmental sealing at the breakout configuration.

Another aspect of the present disclosure relates to embedding an optical fiber breakout block, tensile reinforcement that resists stretching of the mid-span breakout configuration, and a tether retention block within the enclosure.

A further aspect of the present disclosure relates to a mid-span breakout configuration including an optical fiber breakout block having structure that prevents over-mold material from entering the interior of the optical fiber breakout block.

Still another aspect of the present disclosure relates to a molding system for applying over-molds to cables. A multiple piece mold allows insertion of a cable or cable system within a cavity of the mold prior to a first injection of molding material. The molding material is injected into the mold cavity along an inlet channel. The molding system includes provisions to apply the over-mold in multiple stages along the cable. The multiple piece mold further includes a reconfigurable molding cavity when applying the over-mold in multiple stages. Upon initiation of the over-molding process, the reconfigurable molding cavity is set to a first configuration with a first portion of the molding cavity open to the inlet channel and a second portion of the molding cavity closed from the inlet channel by walls within the cavity. The walls can also locate and stabilize certain components of the cable system and/or certain portions of the cable thus serving as intermediate supports. A first injection cycle delivers a first shot of molten molding material filling the first portion of the molding cavity. Upon sufficient solidification of the molding material within the first portion of the molding cavity, interchangeable mold pieces are reconfigured and set to a second configuration. The second configuration opens the second portion of the molding cavity to the inlet channel and removes the walls within the cavity. Upon removal of the walls, the previously injected molding material within the first portion of the molding cavity is open to the second portion of the molding cavity. A second injection cycle delivers a second shot of molten molding material filling the second portion of the molding cavity and fusing the first and second shots of molding material within the molding cavity. The molding system includes provisions to solidify and release the over-molded cable from the multiple piece mold.

Certain cable systems have pressure sensitive components that would be crushed by pressures typically found within injection molding systems. The present disclosure includes provisions to limit the molding pressure within a limit safe for the components being over-molded. In particular, the mold cavity is heated to reduce the viscosity of the injected molding material thus reducing molding pressure. In addition, vents are properly sized and placed to allow the mold cavity to fill without excessive injection pressure. Furthermore, a control system can be provided to limit the injection pressure.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a cross-sectional view illustrating a cable with a first and a second component attached;

FIG. 2 is a cross-sectional view illustrating the cable and components of FIG. 1 installed in a mold set to a first configuration defining a first mold cavity;

FIG. 3 is a cross-sectional view illustrating the cable and the first component of FIG. 1 over-molded by filling the first mold cavity of FIG. 2 with a molding material;

FIG. 4 is a cross-sectional view illustrating the cable and the first and second components of FIG. 1 and the over-mold of FIG. 3 within the mold of FIG. 2 set to a second configuration defining a second mold cavity;

FIG. 5 is a cross-sectional view illustrating the cable and the first and second components of FIG. 1 over-molded by filling the second mold cavity of FIG. 4 with additional molding material;

FIG. 6 is a cross-sectional view illustrating the cable and the first and second components of FIG. 1 and the over-mold of FIG. 5 removed from the mold of FIG. 2 (set to the second configuration of FIG. 4);

FIG. 7 shows a prior art passive fiber optic network;

FIG. 8 is a cross-sectional view of an example distribution cable;

FIG. 9 is a left side view of a mid-span breakout location;

FIG. 10 is an enlarged right side view of the mid-span breakout location of FIG. 9 with an over-mold, wrapping tape, and a protective sleeve removed but represented by dashed outlines;

FIG. 11 is an enlarged right side view of the mid-span breakout location of FIG. 9 with the over-mold and tensile reinforcing member removed, the wrapping tape showing as transparent, and the protective sleeve removed but represented in dashed outline;

FIG. 12 is a cross-sectional view of an example tether cable;

FIG. 13 is a perspective view showing the front, top, and right side of an example breakout block;

FIG. 14 is a perspective view showing the rear, top, and left side of the breakout block of FIG. 13;

FIG. 15 is a perspective view showing the rear, top, and right side of an example retention block;

FIG. 16 is a perspective view showing the front, top, and left side of the retention block of FIG. 15;

FIG. 17 shows an initial preparation of the tether cable of FIG. 12 used at the mid-span breakout location of FIG. 9;

FIG. 18 shows an initial preparation of the distribution cable of FIG. 8 at the mid-span breakout location of FIG. 9;

FIG. 19 is an enlarged perspective view showing the rear, top, and left side of the mid-span breakout location of FIG. 9;

FIG. 20 is an enlarged perspective view showing the front, top, and right side of the mid-span breakout location of FIG. 9;

FIG. 21 is an enlarged perspective view showing the front, top, and right side of the mid-span breakout location of FIG. 9 with a cross-sectional cut made near the front end;

FIG. 22 is an enlarged perspective view showing the rearward, top, and left side of the mid-span breakout location of FIG. 9 with a cross-sectional cut made near the center;

FIG. 23 is an enlarged perspective view showing the rearward, top, and left side of the mid-span breakout location of FIG. 9 with a cross-sectional cut made near the rear end;

FIG. 24 is a perspective view showing the rear, top, and right side of an example assembled mold for over-molding the mid-span breakout location of FIG. 9 including a bottom mold section, a top mold section, a rear mold section, a reconfigurable center mold section, and a front mold section;

FIG. 25 is a perspective view showing the front, top, and left side of the assembled mold of FIG. 24;

FIG. 26 is a perspective view showing the rear, top, and right side of the mold of FIG. 24 with the top mold section separated from the assembly and a first center mold section configured with an inlet connected by passages to a first mold cavity;

FIG. 27 is a perspective view showing the rear, top, and right side of the mold of FIG. 24 with the top mold section separated from the assembly and a second center mold section configured with the inlet connected by passages to a second mold cavity;

FIG. 28 is a perspective view showing the front, top, and right side of the first center mold section of FIG. 26 including the passages along a right half and a left half;

FIG. 29 is a perspective view showing the front, top, and right side of the second center mold section of FIG. 27 including the passages along a right half and a left half;

FIG. 30 is a perspective view showing the rear, top, and right side of the mold of FIG. 24 with the top mold section and the center mold section removed;

FIG. 31 is a perspective view showing the rear, top, and right side of the mold of FIG. 24 with the top mold section, a right half of the rear mold section, the right half (see FIG. 28) of the first center mold section of FIG. 26, and a right half of the front mold section removed, thus partially revealing a vertical longitudinal cross-section of the first mold cavity of FIG. 26;

FIG. 32 is a perspective view showing the rear, top, and right side of the mold of FIG. 24 with the top mold section, the right half of the rear mold section (of FIG. 31), the right half (see FIG. 29) of the second center mold section of FIG. 27, and the right half of the front mold section (of FIG. 31) removed, thus partially revealing a vertical longitudinal cross-section of the second mold cavity of FIG. 27;

FIG. 33 is a perspective view showing the rear, top, and right side of the assembled mold of FIG. 24 in the configuration of FIG. 26 with a cross-sectional cut through the top mold section of FIG. 26, thus revealing the passages of FIG. 28 connecting to a first set of passages of the top mold section;

FIG. 34 is a perspective view showing the rear, top, and right side of the assembled mold of FIG. 24 in the configuration of FIG. 27 with a cross-sectional cut through the top mold section of FIG. 26, thus revealing the passages of FIG. 29 connecting to a second set of passages of the top mold section;

FIG. 35 is a perspective view showing the rear, top, and right side of the assembled mold of FIG. 24 with a cross-sectional cut through the top mold section and with the center mold section removed, thus revealing the second set of passages of FIG. 34 of the top mold section connecting to the second mold cavity of FIG. 27 and to a second set of passages of the bottom mold section;

FIG. 36 is a perspective view showing the rear, top, and left side of the bottom mold section of the mold of FIG. 24;

FIG. 37 is a perspective view showing the front, bottom, and right side of the top mold section of the mold of FIG. 24 revealing the first set of passages of FIG. 33 connecting to the first mold cavity of FIG. 26;

FIG. 38 is a cross-sectional perspective view showing the rearward, top, and left side of the bottom mold section of the mold of FIG. 24 revealing a first set of passages of the bottom mold section connecting to the first mold cavity of FIG. 26 and the second set of passages (see FIG. 35) of the bottom mold section connecting to the second mold cavity of FIG. 27;

FIG. 39 is a cross-sectional perspective view showing the forward, bottom, and right side of the top mold section of the mold of FIG. 24 revealing the first set of passages of FIG. 33 of the top mold section connecting to the first mold cavity of FIG. 26 and the second set of passages of FIG. 34 of the top mold section connecting to the second mold cavity of FIG. 27;

FIG. 40 is a perspective view showing the rear, bottom, and right side on an inlet block for use with the inlets of FIGS. 26 and 27;

FIG. 41 is a perspective view showing the front, top, and left side of a press base for use in primarily holding the bottom mold section of the mold of FIG. 24; and

FIG. 42 is a perspective view showing the rear, bottom, and right side of a press top for use in primarily holding the top mold section of the mold of FIG. 24 and the inlet block of FIG. 40.

### DETAILED DESCRIPTION

The present disclosure relates to applying an over-mold on or around slender and/or flexible objects, such as an optical cable, by injecting a liquid molding material within a mold cavity of a mold. In a preferred embodiment, the liquid molding material is at an elevated temperature when injected and solidifies when cooled. In other embodiments, a chemical reaction, a photochemical reaction, and/or a thermochemical reaction can solidify the liquid molding material.

One or more slender and/or flexible objects, hereinafter called core bodies (body), are placed within the mold cavity prior to injecting the molding material. The core body (bodies) extends outside the mold cavity at one or more port locations. The mold has an opening that seals around the core body at each port location.

In a preferred embodiment, the mold includes multiple mold pieces that are reconfigurable to form multiple mold cavities. The multiple mold cavities are of successively larger volumes and filled in succession from the smallest volume mold configuration to the largest. An initial configuration of the mold forms an initial mold cavity with the smallest volume and is loaded with the core body (bodies). Additional components which are entirely within the mold cavity can also be loaded and preferably attached to one or more core bodies. Initial port locations are adequate to support the core bodies within the initial mold cavity and prevent unacceptable movement during an initial over-molding process. In a preferred embodiment, the initial configuration includes multiple mold pieces that define the initial mold cavity and can also include other mold pieces not used in defining the initial mold cavity. The core bodies and the additional components can also be loaded into the initially unused mold pieces. An initial injection cycle fills a portion of the initial mold cavity that is not occupied by the core bodies or the additional components with the liquid molding material forming an initial over-mold.

After injecting the molding material within the initial mold cavity, the initial over-mold can be allowed to cool and/or solidify to a desired degree. The mold is then reconfigured into a second configuration forming a second mold cavity. Certain portions of the initial mold cavity can also define certain portions of the second mold cavity. In a preferred embodiment, the mold pieces that define a portion of the initial mold cavity and completely correspond to portions of the second mold cavity are reused. In a preferred embodiment, the initial over-mold is left undisturbed within the reused mold pieces shared by the initial configuration and the second configuration. New mold pieces are introduced to the mold to form the second configuration and can replace mold pieces used in the initial configuration. Typically, the new mold pieces define portions of the second mold cavity. Certain of the initially unused mold pieces in the initial configuration can define portions of the second mold cavity. Thus the second mold cavity is defined with reused mold pieces, new mold pieces, and initially unused mold pieces. The second mold cavity may already be loaded with the core bodies and additional components that were initially loaded into the mold. Other core bodies and additional components can be loaded within the second mold cavity. The solidified or partially solidified initial over-mold can provide support to portions of the core bodies not yet over-molded during a second over-molding process. Additional port locations can engage the core bodies. The combination of the port locations and the initial over-mold are adequate to support the core bodies within the second mold cavity and prevent unacceptable movement during the second over-molding process. A second injection cycle fills the portion of the second mold cavity that is not occupied by the core bodies, the additional components, or the initial over-mold with the liquid molding material forming a second over-mold.

After injecting the molding material within the second mold cavity, the second over-mold can be allowed to cool and/or solidify to a desired degree. The above process may be continued with additional mold configurations and additional over-molds or the over-molded core body (bodies) may be removed from the mold.

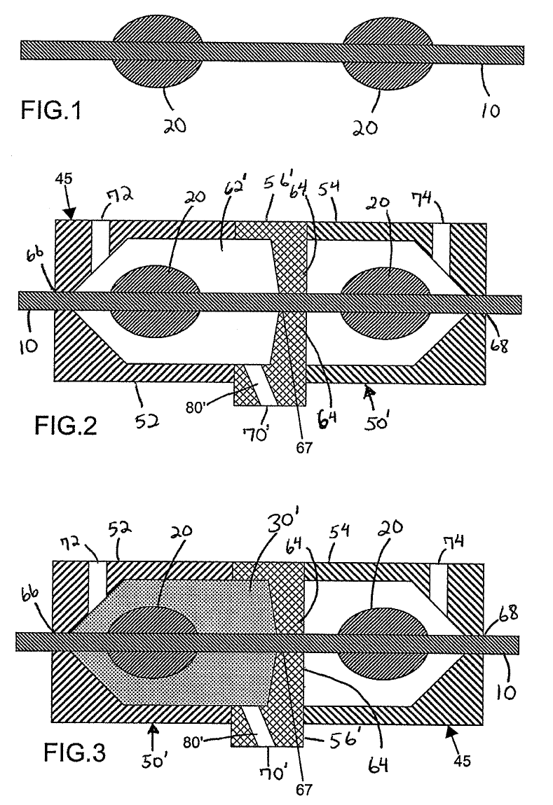

Turning now to the figures and in particular to FIGS. 1 through 6 there is shown an example over-mold 30 being over-molded onto a cable 10. Additional example components 20 have been previously applied to the cable 10 and are also over-molded by the over-mold 30. Together, the over-mold 30, the additional components 20, and the cable 10 form an example cable system 40. An example mold 45 with multiple configurations is used to over-mold the cable 10.

The mold 45 is initially set to an initial configuration 50′ as shown at FIGS. 2 and 3 including a first mold section 52, a second mold section 54, and an initial center mold section 56′. The initial center mold section 56′ includes an inlet 70′ directed to a first mold cavity 62′ by a first passage 80′. The first mold cavity 62′ is formed by the first mold section 52 and the initial center mold section 56′. The initial center mold section 56′ includes a wall 64 which excludes the second mold section 54 from the first mold cavity 62′. The cable 10 and additional component 20 are placed within the first mold cavity 62′ and can also be placed within the second mold section 54. Ports 66, 67 of the first mold section 52 and the initial center mold section 56′ support the cable 10 within the first mold cavity 62′ and form a seal around the cable 10. A port 68 of the second mold section 54 can also support the cable 10 outside the first mold cavity 62′. The cable 10 supports the additional components 20. A first vent 72 allows air to escape the first mold cavity 62′ and also prevents excess pressure from developing within the cavity 62′.

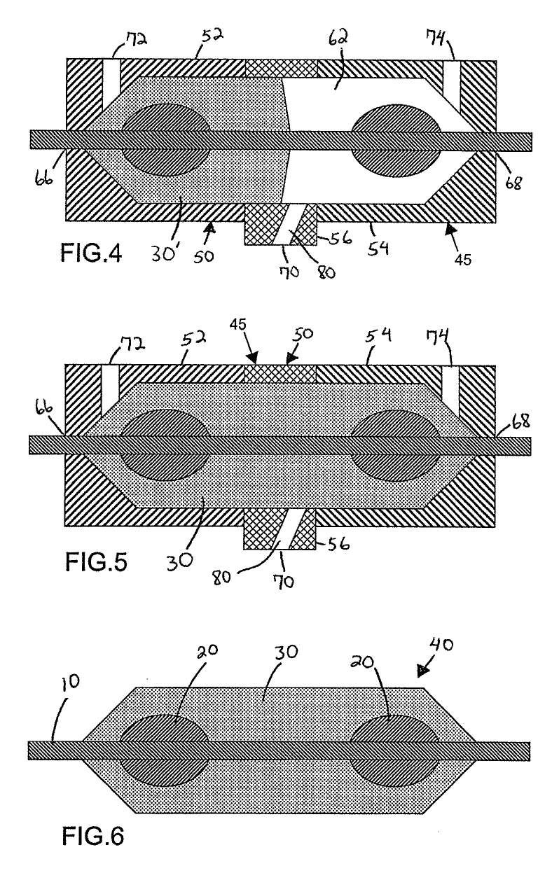

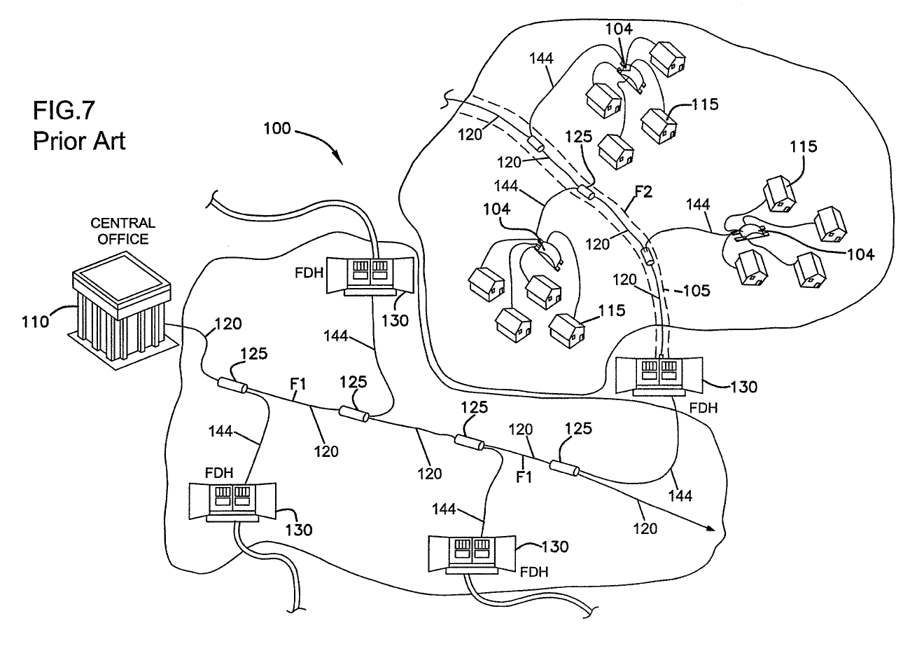

As shown at FIG. 3, the first mold cavity 62′ is injected with a molten molding material creating an initial over-mold 30′. Excess molding material can exit through the first vent 72. The initial over-mold 30′ is allowed to cool until it is sufficiently solid. The initial center mold section 56′ is removed from the mold 45 and replaced with a final center mold section 56 as shown at FIG. 4, setting the mold 45 to a final configuration 50. The cable 10, additional components 20, and the initial over-mold 30′ are left undisturbed in the first and second mold sections 52, 54 while the center mold sections 56′, 56 are switched. The final center mold section 56 includes an inlet 70 directed to a second mold cavity 62 by a second passage 80. The second mold cavity 62 is formed by the first mold section 52, the final center mold section 56, and the second mold section 54. The port 68 of the second mold section 54 supports the cable 10 within the second mold cavity 62 and forms a seal around the cable 10. Additional support is provided to the cable 10 by the initial over-mold 30′. A second vent 74 allows air to escape the second mold cavity 62 and also prevents excess pressure from developing within the cavity 62.

As shown at FIG. 5, the second mold cavity 62 is injected with additional molten molding material combining with the initial over-mold 30′ to create a final over-mold 30. Excess molding material can exit through the second vent 74. The additional molten molding material can fuse with the initial over-mold 30′. The final over-mold 30 is allowed to cool until it is sufficiently solid. The mold is then removed from the cable system 40 as shown at FIG. 6.

Aspects of the present disclosure relate to manufacturing mid-span breakout configurations for pre-terminated fiber optic distribution cables. In particular, a molding system is disclosed that is particularly well suited for over-molding features onto slender and flexible objects such as fiber optic cables. The molding system can employ a mold with intermediate supports to hold the fiber optic distribution cable, at least one fiber optic tether cable, and other components of the mid-span breakout configuration while over-molding to prevent unacceptable movement of and stresses within the cables and components. The mold may further employ multiple cavities filled by a sequence of multiple injection cycles. The mold can be reconfigured between the injection cycles. In addition, the molding system allows the fiber optic distribution cable, the at least one fiber optic tether cable, and the other components of the mid-span breakout configuration to be assembled and placed within the multiple mold cavities of the mold prior to over-molding thus resulting in the components being embedded within the over-mold.

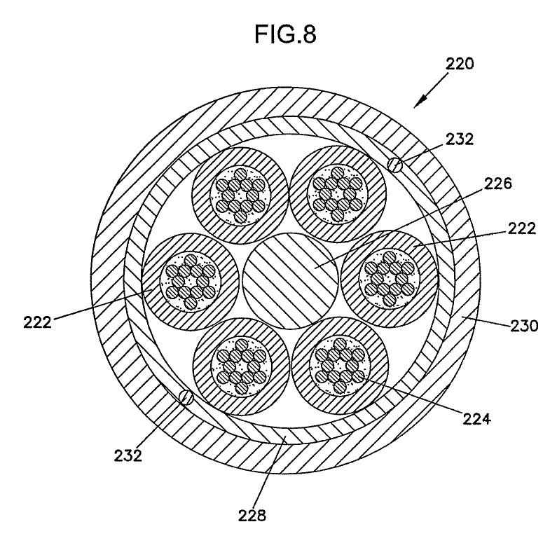

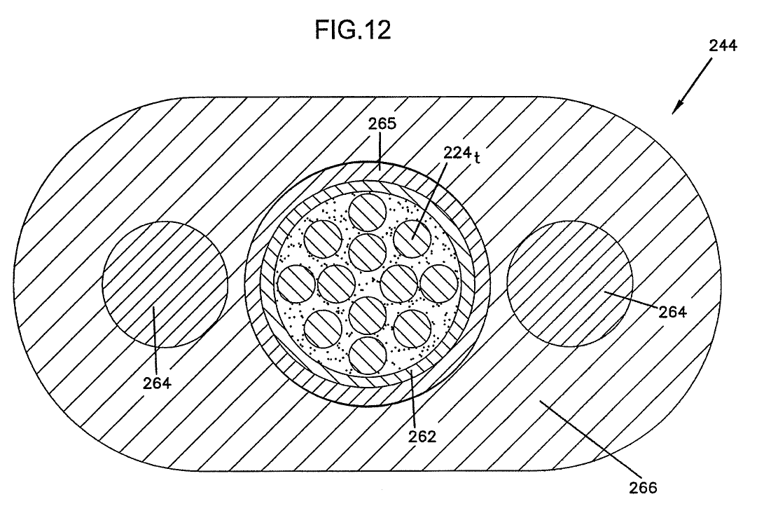

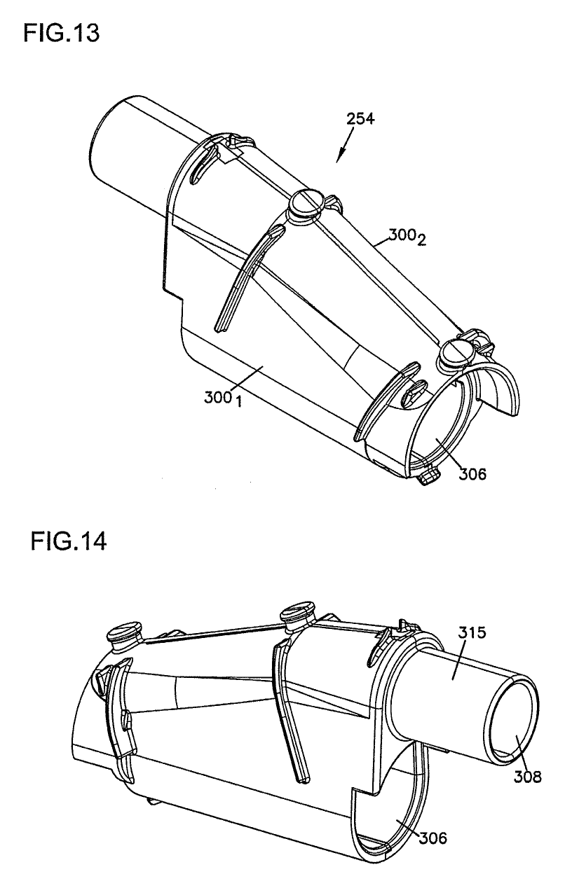

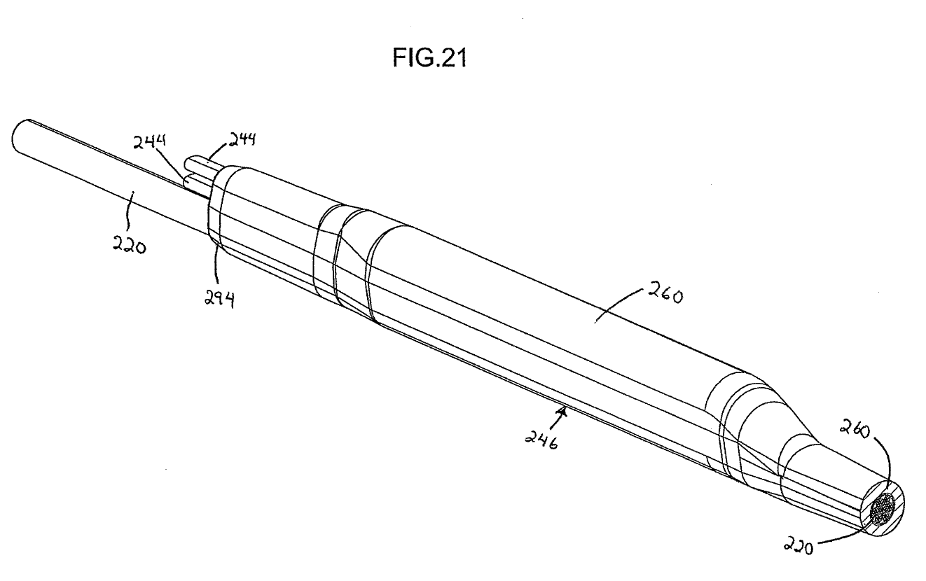

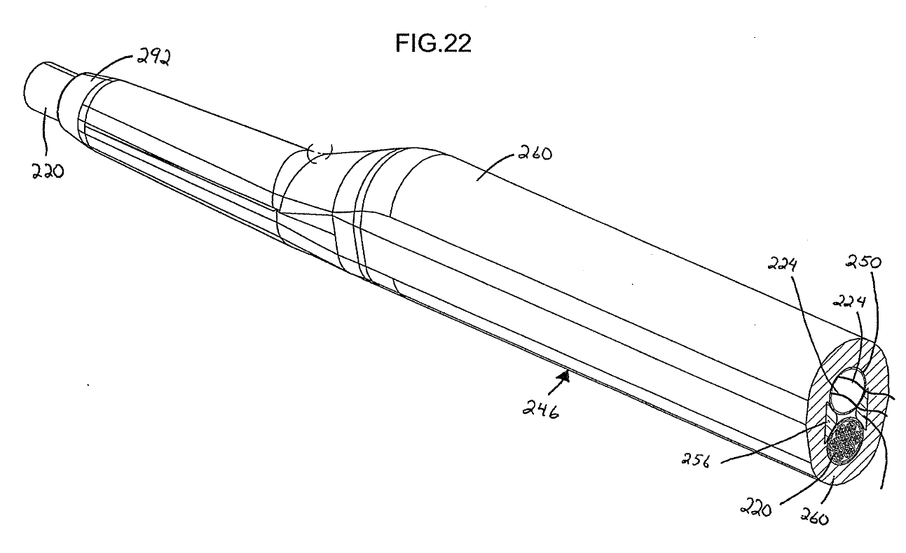

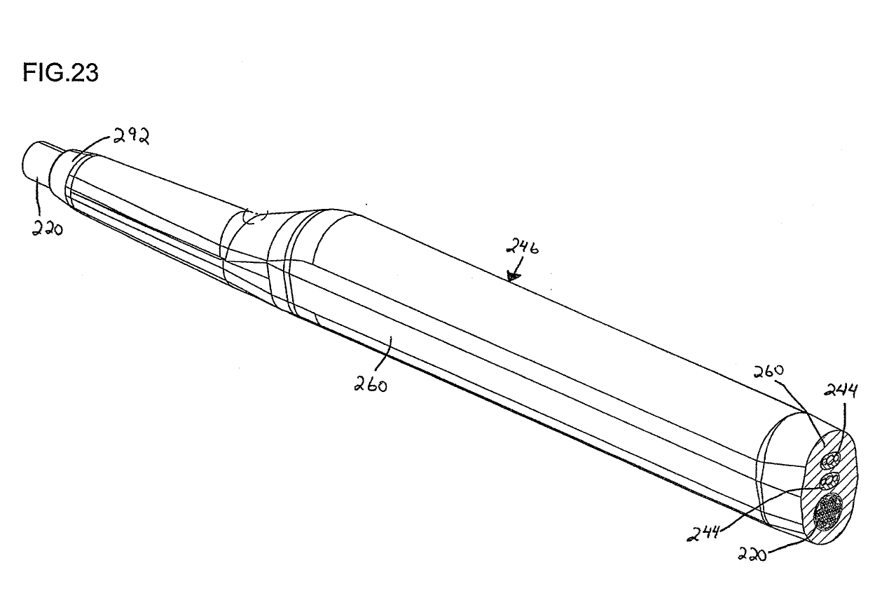

Turning now to FIGS. 8 through 23 there is shown an example fiber optic cable breakout configuration. A fiber optic cable assembly 240 including the breakout configuration is more fully described at U.S. patent application Ser. No. 11/787,218, filed Apr. 12, 2007, and U.S. Patent Application Publication Number 2008/0253729, published Oct. 16, 2008, both entitled FIBER OPTIC CABLE BREAKOUT CONFIGURATION WITH TENSILE REINFORCEMENT, which are hereby incorporated by reference in their entirety.

FIG. 8 shows an example distribution cable 220 including six separate buffer tubes 222 each containing twelve optical fibers 224. The fibers can include either ribbon fibers or loose fibers. The buffer tubes 222 can be gel filled. The distribution cable 220 also includes a central strength member 226 for reinforcing the cable 220. The distribution cable 220 further includes an outer jacket 230 that encloses the buffer tubes 222. In certain embodiments, ripcords 232 can be provided for facilitating tearing away portions of the jacket 230 to access the optical fibers 224 within the jacket 230. The distribution cable 220 can also include a strength layer 228 for providing further tensile reinforcement to the distribution cable 220. In one embodiment, the strength layer includes a plurality of strength members such as aramid yarn (i.e., KEVLAR®) for further reinforcing the cable.

The distribution cable 220 of FIG. 8 is merely one example of a type of cable to which the various aspects of the present disclosure apply. Other distribution cable configurations can also be used. For example, the distribution cable 220 can include an outer jacket enclosing a single buffer tube and at least two strength members extending on opposite sides of the single buffer tube. An outer strength member such as aramid yarn can surround the single buffer tube within the jacket. The single buffer tube can enclose loose fibers or ribbon fibers.

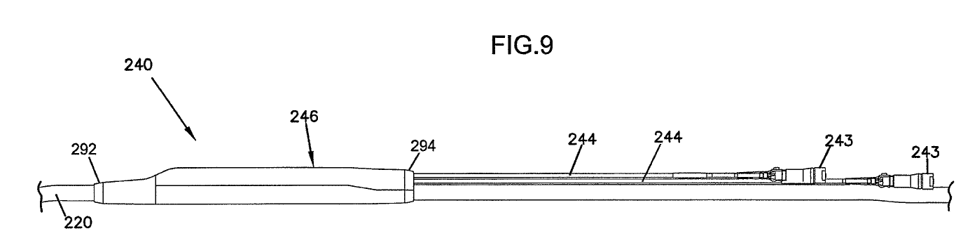

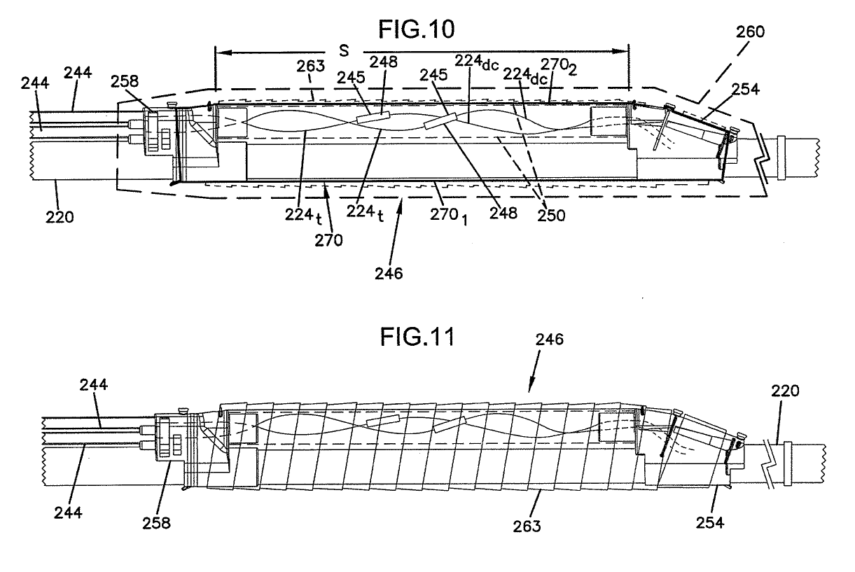

The typical mid-span breakout location is provided at an intermediate point along the length of a distribution cable. Commonly one or more tethers (e.g., drop cables or stub cables) branch out from the distribution cable at the breakout location. FIGS. 9-11 illustrate the fiber optic cable assembly 240 which may be over-molded by an over-mold 260 to protect the internal components of the assembly 240 from the environment. The fiber optic cable assembly includes a distribution cable 220 and tethers 244 that branch from the distribution cable 220 at a mid-span breakout location 246. Multi-fiber optic connectors 243 are mounted at free ends of the tethers 244. As shown at FIG. 10, the breakout location 246 includes splice locations 245 where selected optical fibers 224_{dc} of the main distribution cable 220 are spliced to corresponding optical fibers 224ₜ of the tethers 244. Splice sleeves 248 are provided over the splices at the splice locations 245. The splice sleeves 248 are within a protective sleeve 250 (e.g., a plastic tube) that extends along a length of the breakout location 246 and has a first end supported by a breakout block 254 and an opposite second end supported by a retention block 258.

The breakout location 246 has a front end 292 and a rear end 294 that correspond to a common field installation process of pulling the front end 292 through a conduit 105 first with the rear end 294 and the tethers 244 trailing. Other installation processes are also possible.

FIG. 12 is a cross-sectional view representative of an example configuration for the tethers 244 joined to the distribution cable 220 at the breakout location 246. The depicted configuration has a flat profile and includes a central buffer tube 262 containing a plurality of optical fibers 224ₜ (e.g., typically one to twelve loose or ribbonized fibers). Strength members 264 (e.g., flexible rods formed by glass fiber reinforced epoxy) are positioned on opposite sides of the central buffer tube 262. An outer jacket 266 surrounds the strength members 264 and the buffer tube 262. The outer jacket 266 includes an outer perimeter having an elongated transverse cross-sectional shape. An additional strength layer 265 (e.g., aramid yarn) can be positioned between the buffer tube 262 and the outer jacket 266.

To maintain a desired amount of slack within the optical fibers 224_{dc}, 224ₜ located within the protective sleeve 250, it is desired to maintain a set spacing S between the breakout block 254 and the retention block 258. To ensure that the spacing S is maintained, the mid-span breakout location 246 includes a tensile reinforcing arrangement that mechanically ties or links the breakout block 254 to the retention block 258. The tensile reinforcing structure assists in maintaining the spacing S by resisting stretching of the over-mold 260 at the mid-span breakout location 246. In the embodiment of FIG. 10, the tensile reinforcing arrangement includes a tensile reinforcing member 270 that extends between the breakout block 254 and the retention block 258, and is anchored to the breakout block 254 and the retention block 258. In one embodiment, the tensile reinforcing member 270 is a flexible member such as a rope, string, strand, or wire. In a preferred embodiment, the tensile reinforcing member 270 is constructed of aramid yarn (i.e., KEVLAR®).

In the embodiment of FIG. 10, the tensile reinforcing member 270 includes a first segment 270₁ and a second segment 270₂. The first segment 270₁ extends from the breakout block 254 to the retention block 258 at a location on a first side (e.g., a bottom side) of the distribution cable 220. The second segment 270₂ extends from the breakout block 254 to the retention block 258 at an opposite second side (e.g., a top side) of the distribution cable 220.

Referring to FIGS. 13 and 14, the breakout block 254 provided at the mid-span breakout location 246 includes a first piece 300₁ that forms a right side of the breakout block 254 and a second piece 300₂ that forms a left side of the breakout block 254. The first and second pieces 300₁, 300₂ are connected at an upper seam and a lower seam. In one embodiment, a bonding material (e.g., epoxy) is used at the upper and lower seams to connect the first and second pieces 300₁, 300₂ together.

Referring still to FIGS. 13 and 14, the breakout block 254 defines a straight-through channel 306 and a breakout channel 308. The straight-through channel 306 has an inner diameter that generally matches the outer diameter of the outer jacket 230 of the distribution cable 220. The breakout channel 308 is configured to separate the accessed optical fibers 224_{dc} from the distribution cable 220 by routing the optical fibers 224_{dc} outwardly from the distribution cable 220 to the protective sleeve 250. The breakout channel 308 includes an opening for routing the optical fibers 224_{dc} radially outwardly from the distribution cable 220 into the breakout channel 308. The breakout channel 308 also includes a second opening for routing the optical fibers 224_{dc} outwardly from the breakout channel 308 and into the protective sleeve 250. As best shown at FIG. 14, the second opening is defined by a cylindrical stem 315 sized to fit within the first end of the protective sleeve 250.

The upper and lower seams of the breakout block 254 are preferably configured to prevent over-mold material from seeping into the interior of the breakout block 254 during the over-molding process.

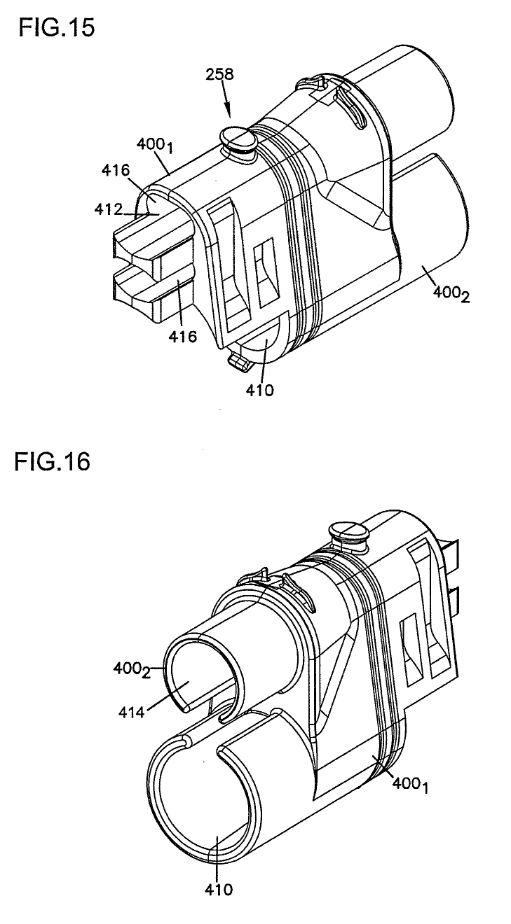

Referring to FIGS. 15 and 16, the retention block 258 used at the mid-span breakout location 246 includes a first piece 400₁ that forms a left side of the retention block 258 and a second piece 400₂ that forms a right side of the retention block 258. The first and second pieces 400₁, 400₂ of the retention block 258 are joined together at upper and lower seams. A bonding material such as epoxy can be used to secure the first and second pieces 400₁, 400₂ together at the upper and lower seams.

Referring still to FIGS. 15 and 16, the retention block 258 defines a generally cylindrical straight-through passage 410. The straight-through passage 410 defines an inner diameter sized to correspond with the outer diameter of the outer jacket 230 of the distribution cable 220. When the retention block 258 is mounted on the distribution cable 220, the distribution cable 220 extends through the straight-through passage 410 and may be bonded to the straight-through passage 410. The retention block 258 also defines a tether passage arrangement 412 that passes through the retention block 258. The tether passage arrangement 412 is adapted for receiving ends of the tethers 244.

Adjacent the front end of the retention block 258, the tether passage arrangement 412 is defined by a generally cylindrical stem 414 that fits within the second end of the protective sleeve 250. At the rear end of the retention block 258, the tether passage arrangement defines two tether receptacles 416.

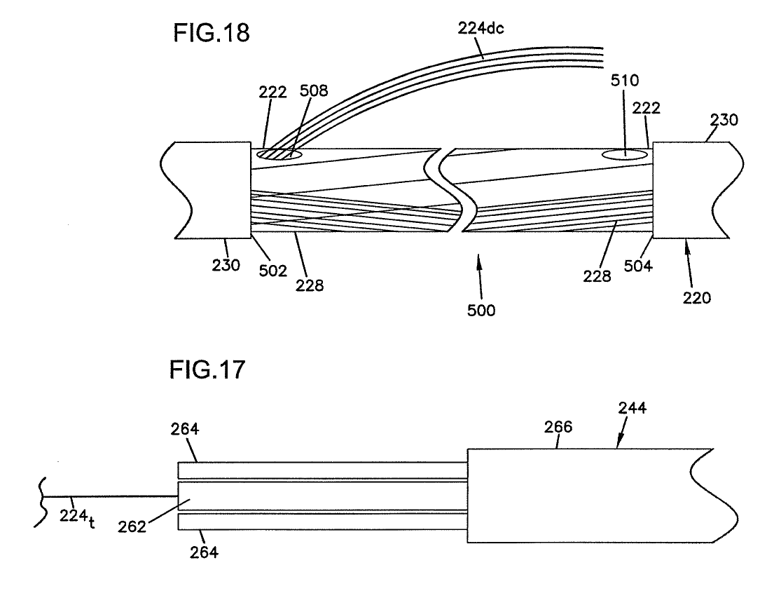

To prepare the mid-span breakout location on the distribution cable 220, a portion of the outer jacket 230 is first ring cut and stripped away (see FIG. 18) to provide a stripped region 500 having an upstream end 502 and a downstream end 504. The outer strength member 228 can also be displaced (e.g., bunched at the bottom side of the cable) adjacent the ends 502, 504 to facilitate accessing the buffer tubes 222. One of the buffer tubes 222 is then selected and a first window 508 is cut into the buffer tube adjacent the upstream end 502 of the stripped region 500 and a second window 510 is cut into the buffer tube 222 adjacent the downstream end 504 of the stripped region 500. The optical fibers 224_{dc} desired to be broken out are then accessed and severed at the second window 510. After the optical fibers 224_{dc} have been severed, the optical fibers 224_{dc} are pulled from the buffer tube 222 through the first window 508. With the distribution cable 220 prepared as shown at FIG. 18, the optical fibers 224_{dc} are ready to be terminated to the prepared tether 244 of FIG. 17.

To connect the tethers 244 to the distribution cable 220 at the mid-span breakout location 246, the protective sleeve 250 is first slid over the exterior of the pre-prepared tethers 244. The splice sleeves 248 can also be slid over the optical fibers 224ₜ of each of the tethers 244. A polymeric binder or resin is then applied to the ends of the exposed optical fibers 224_{dc}, 224ₜ to encase and ribbonize the ends of the optical fibers 224_{dc}, 224ₜ. The ribbonized ends of the optical fibers 224_{dc}, 224ₜ are then fusion spliced together. After the fusion splice has been completed, the splice sleeves 248 are slid over the fusion splices to protect the splice locations 245.

Once the optical fibers 224_{dc}, 224ₜ have been fused together, the breakout block 254 is mounted to the distribution cable 220. The first and second pieces 300₁, 300₂ of the breakout block 254 are then mounted over the distribution cable 220 adjacent the upstream end 502 of the stripped region 500. As the first and second pieces 300₁, 300₂ of the breakout block 254 are mounted over the distribution cable 220, the optical fibers 224_{dc} are positioned to extend through the breakout channel 308. Thereafter, the protective sleeve 250 is slid over the optical fibers 224_{dc}, 224ₜ such that the first end fits over the cylindrical stem 315 provided at the rear end of the breakout block 254.

Next, the retention block 258 is mounted at the downstream end 504 of the stripped region 500. The first and second pieces 400₁, 400₂ of the retention block 258 are then mounted around the distribution cable 220 with the tether optical fibers 224ₜ extending through the tether passage arrangement 412 and the stripped region 500 of the distribution cable 220 extending through the straight through-channel 410. The cylindrical stem 414 of the retention block 258 is inserted into the second end of the protective sleeve 250.

Once the breakout block 254, the retention block 258 and the protective sleeve 250 have been secured to the distribution cable 220, the tensile reinforcing member 270 can be secured to the assembly in the manner previously described. Thereafter, tape 263 can be wrapped about the mid-span breakout location 246.

The fiber optic cable assembly 240, prepared above, is over-molded with the over-mold layer 260 about the mid-span breakout location 246 to complete the manufacturing process.

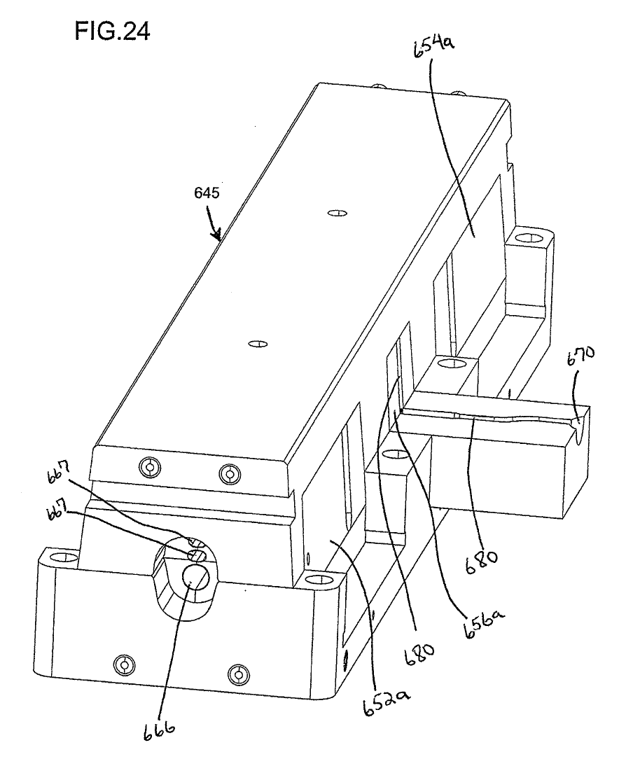

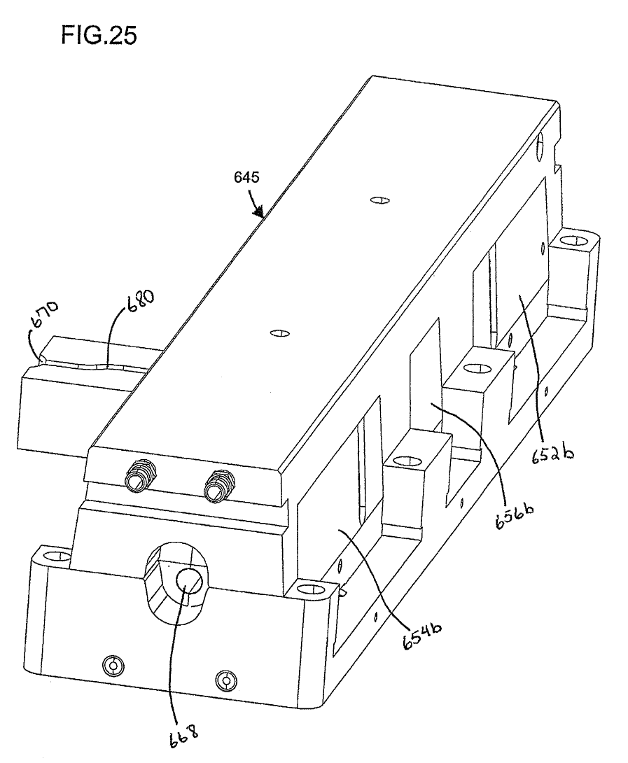

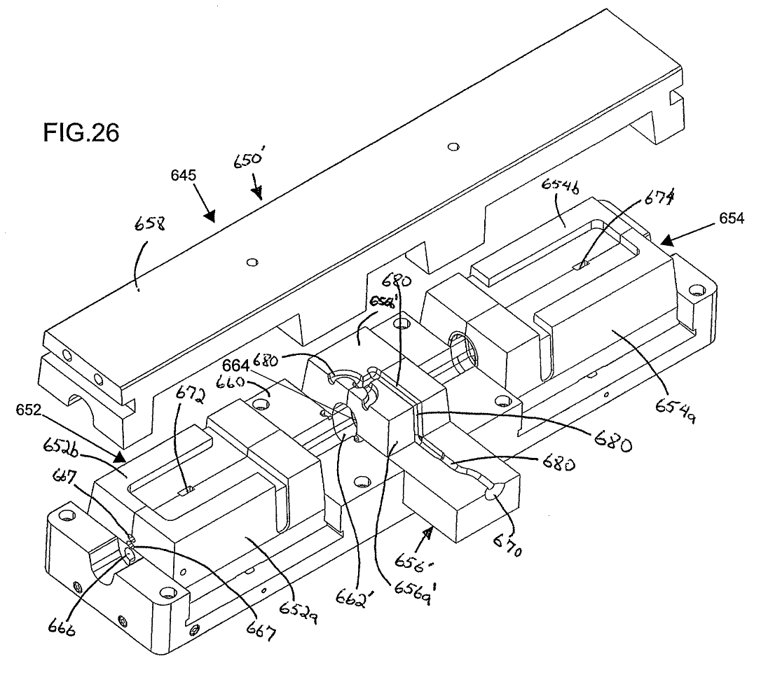

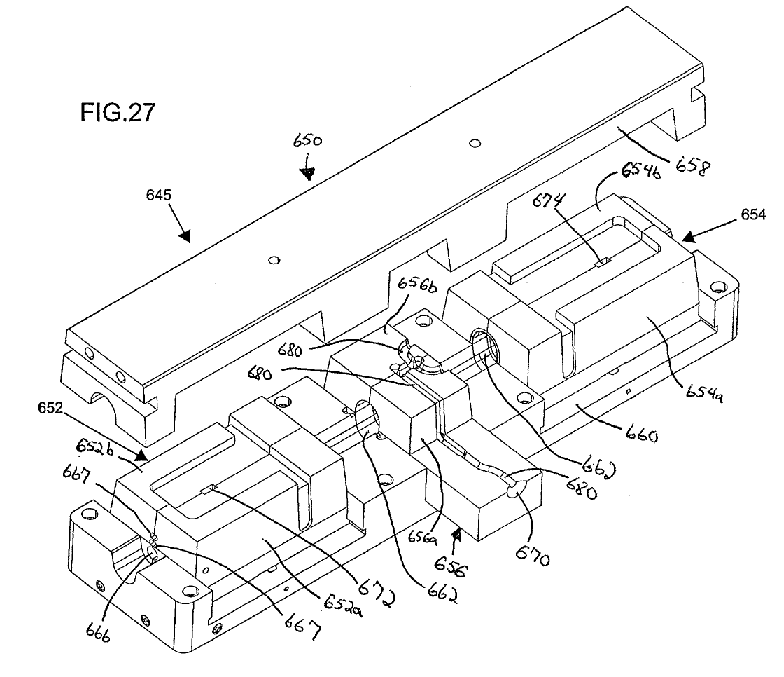

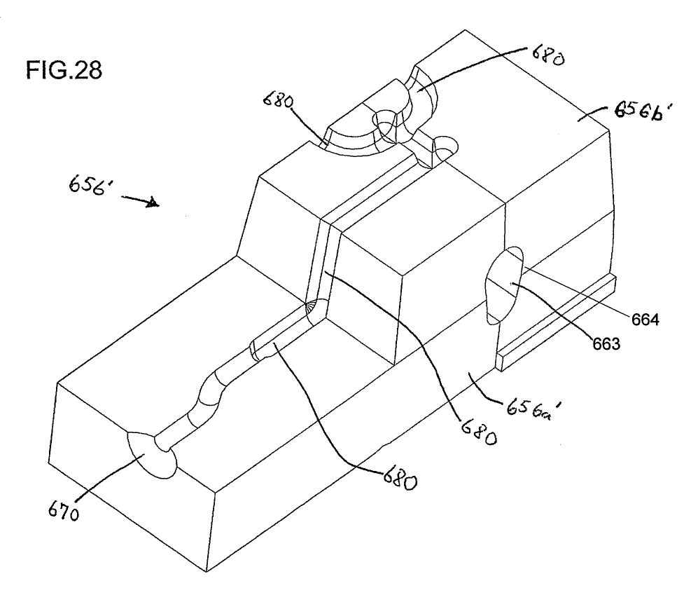

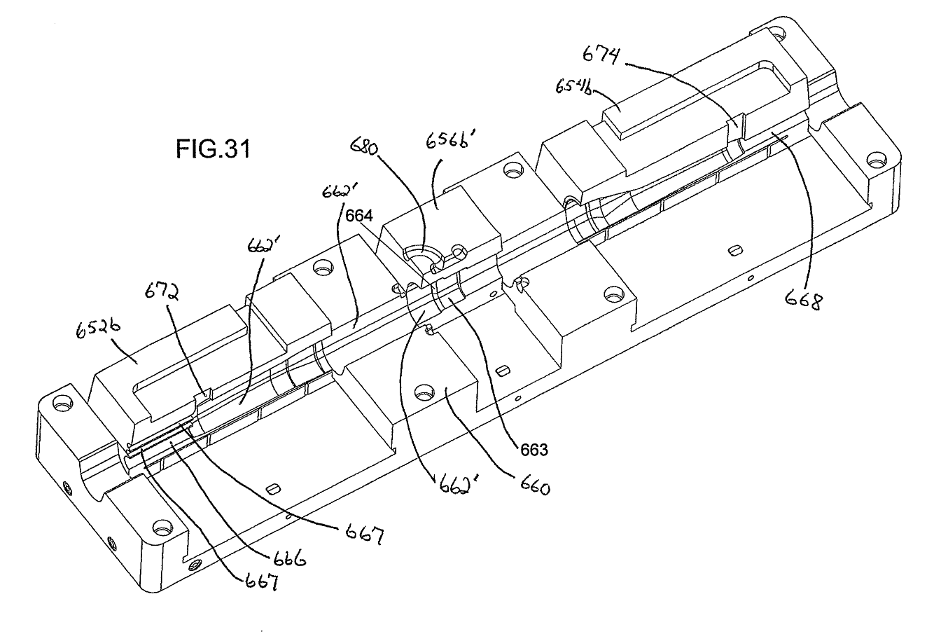

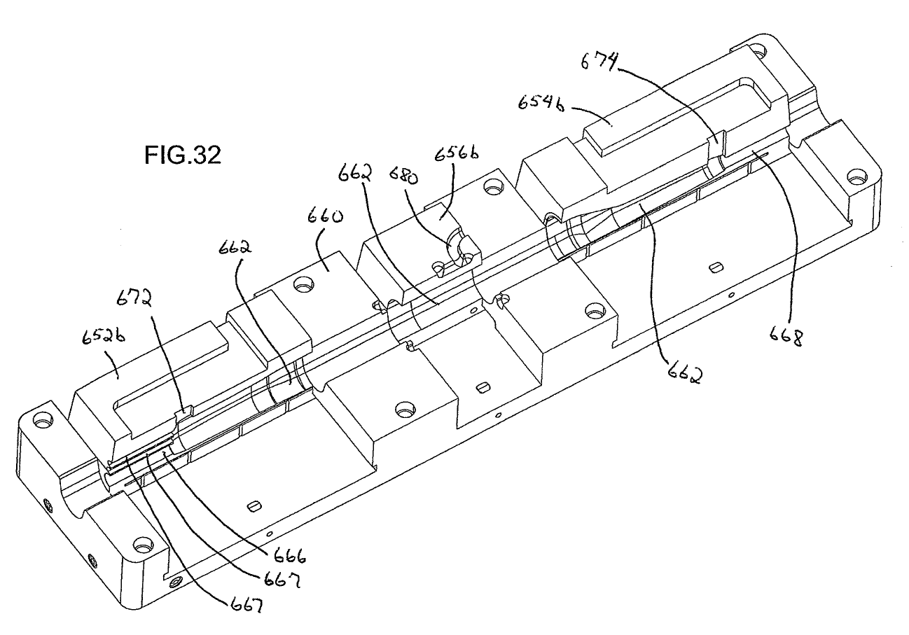

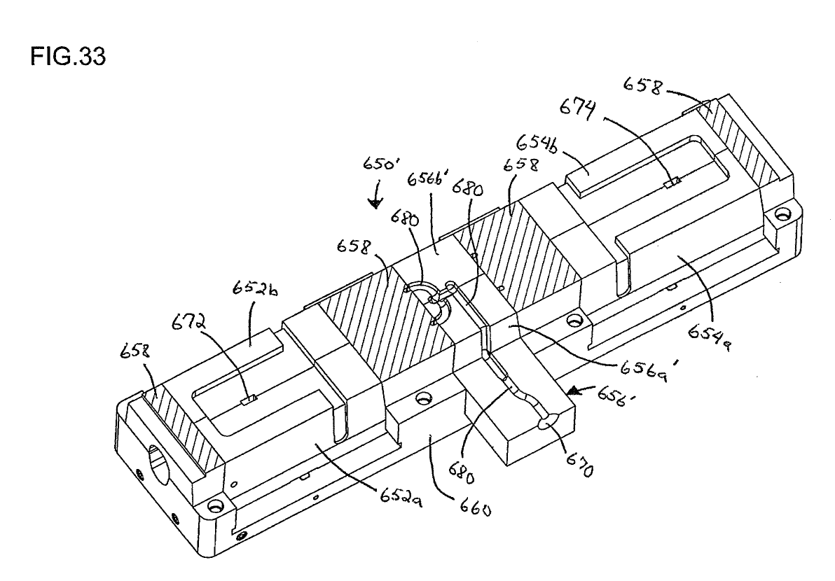

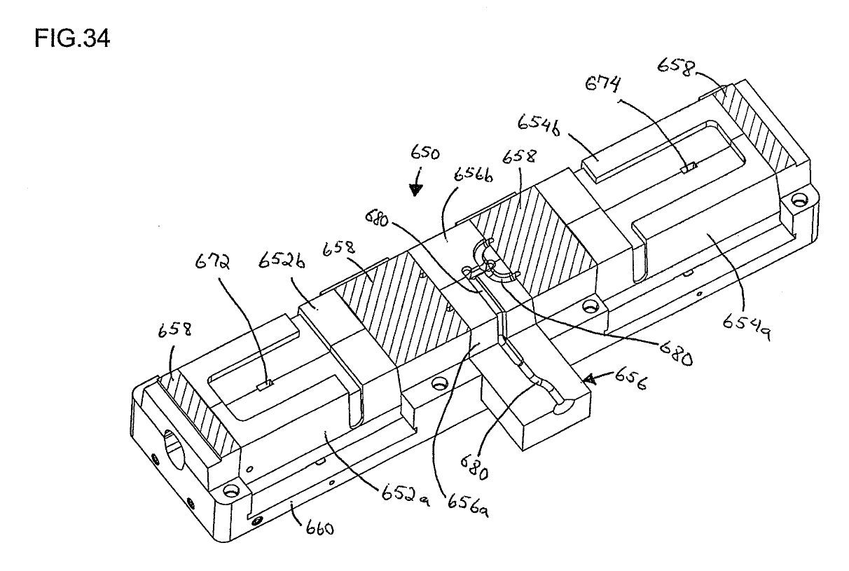

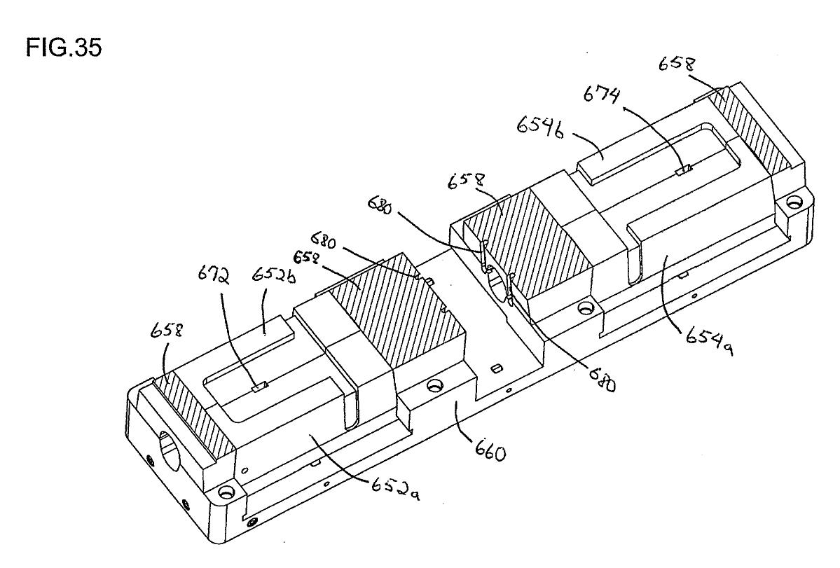

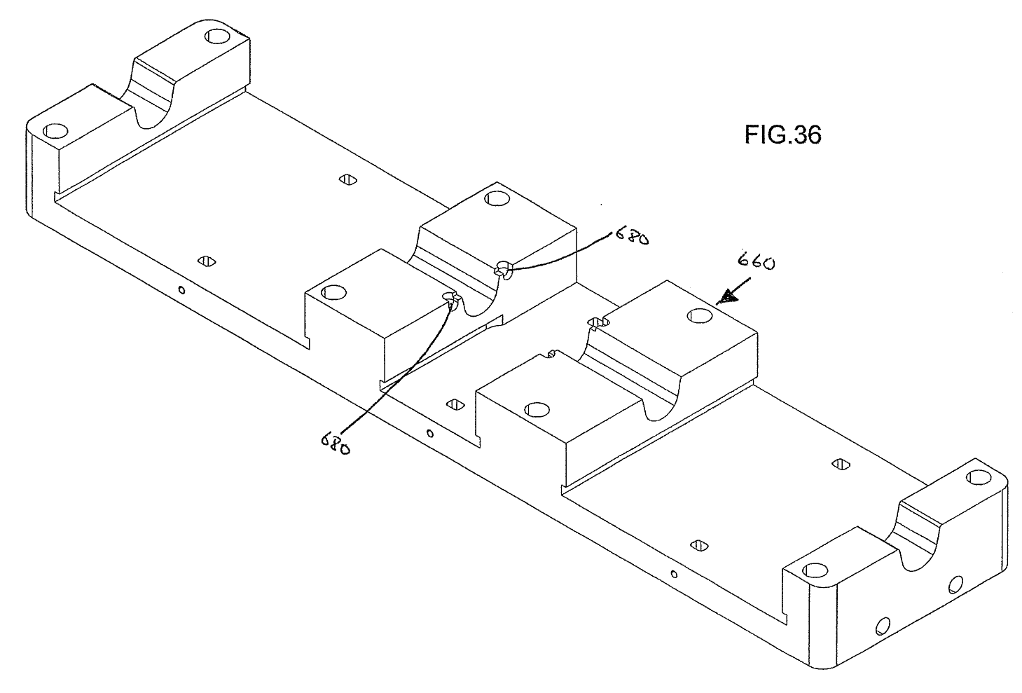

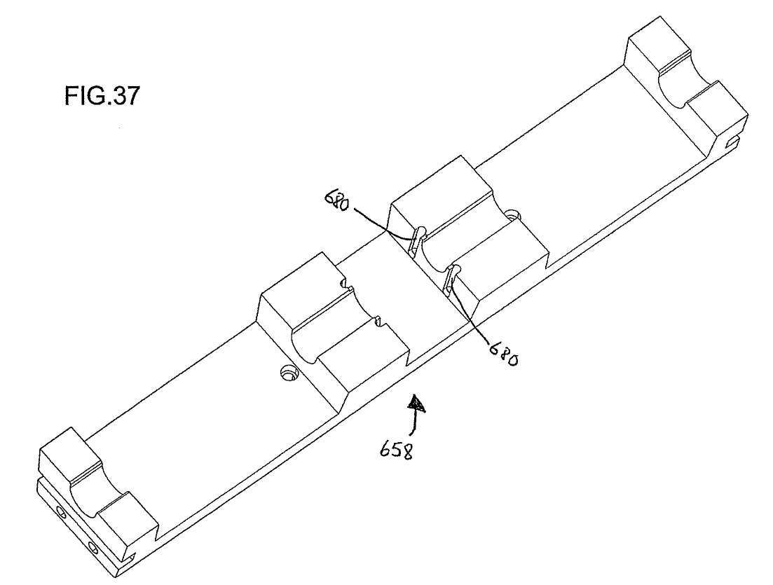

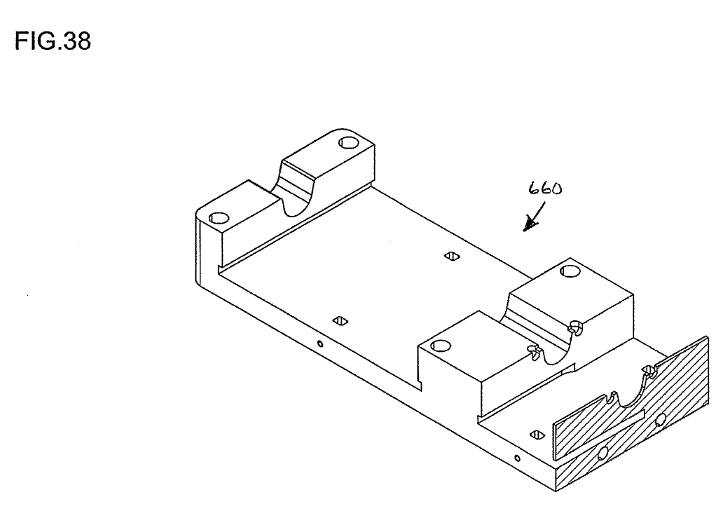

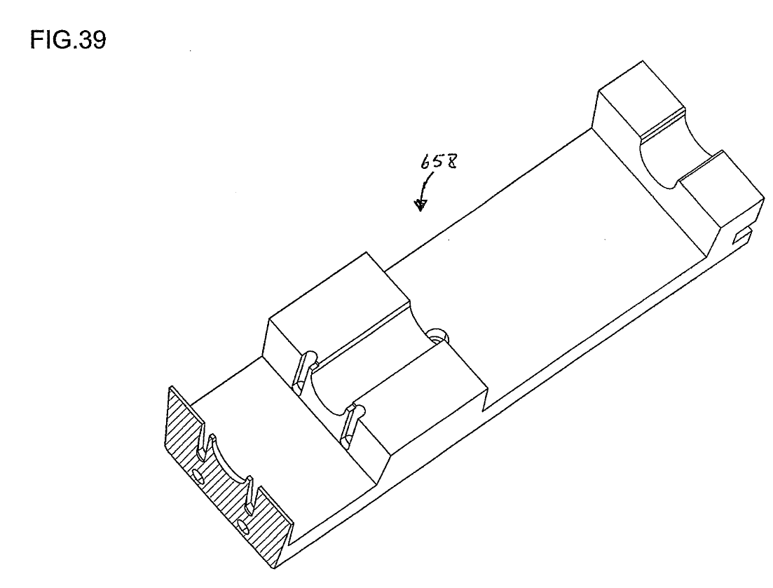

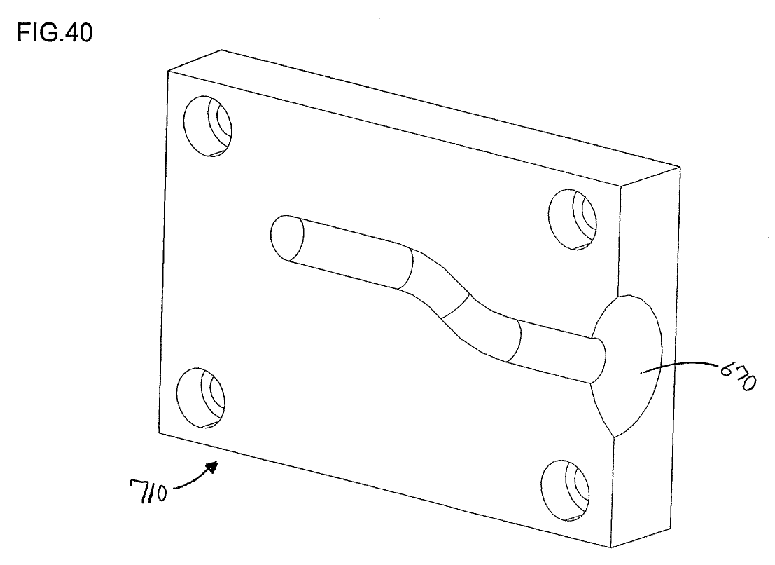

An exemplary mold 645 is illustrated at FIGS. 24 through 39. An initial configuration 650′ (shown at FIG. 26) forms a first mold cavity 662′ and a final configuration 650 (shown at FIG. 27) forms a second mold cavity 662 within the mold 645. Similarities exist between the example mold 45 of FIGS. 2 through 5 and the example mold 645 of FIGS. 24 through 27 in that an appropriate and corresponding cable assembly is placed within the mold 45, 645 in the initial configuration 50′, 650′. The first mold cavity 62′, 662′ is then injected with a molding material that fills the first mold cavity 62′, 662′ and forms an initial over-mold. The mold 45, 645 is then reconfigured to the final configuration 50, 650 forming the second mold cavity 62, 662. The second mold cavity 62, 662 is then injected with additional molding material that fills the second mold cavity 62, 662 and forms a final over-mold 30, 260.

In particular, the mold 645 is initially set to the initial configuration 650′ as shown at FIGS. 26, 31, and 33 including a first mold section 652, a second mold section 654, an initial center mold section 656′, a top mold section 658, and a bottom mold section 660. The initial center mold section 656′ includes an inlet 670 directed to the first mold cavity 662′ by a passage 680. The first mold cavity 662′ is formed by the first mold section 652, the initial center mold section 656′, and portions of the top mold section 658 and the bottom mold section 660. The initial center mold section 656′ includes a wall 664 which excludes the second mold section 654 and remaining portions of the top mold section 658 and the bottom mold section 660 from the first mold cavity 662′. The fiber optic cable assembly 240 is placed within the first mold cavity 662′ and can also be placed within the second mold section 654. Ports 666, 667 of the first mold section 652 and a port 663 of the initial center mold section 656′ support the cable assembly 240 within the first mold cavity 662′ and form a seal around the cable assembly 240. A port 668 of the second mold section 654 can also support the cable assembly 240 outside the first mold cavity 662′. In particular, the ports 666 and 668 hold and seal the distribution cable 220 and the ports 667 hold and seal one or more tether cable 244. In certain configurations of the fiber optic cable assembly 240, certain tether cables 244 and/or distribution cables 220 may not be present and/or may not extend through one or more of their respective ports 666, 667, 668. In this case, the unused ports 666, 667, 668 can be plugged. A first vent 672 allows air to escape the first mold cavity 662′ and also prevents excess pressure from developing within the cavity 662′.

The first mold cavity 662′ is injected with a molten molding material creating an initial over-mold. Excess molding material can exit through the first vent 672. The initial over-mold is allowed to cool until it is sufficiently solid. The initial center mold section 656′ is removed from the mold 645 and replaced with a final center mold section 656 as shown at FIGS. 27, 32, and 34. The fiber optic cable assembly 240 is left undisturbed in the first and second mold sections 652, 654 while the center mold sections 656′, 656 are switched. The top mold section 658 can be raised to facilitate the switch. The final center mold section 656 includes another inlet 670 directed to the second mold cavity 662 by a passage 680. The second mold cavity 662 is formed by the first mold section 652, the final center mold section 656, the second mold section 654, the top mold section 658, and the bottom mold section 660. The port 668 of the second mold section 654 supports the fiber optic cable assembly 240 within the second mold cavity 662 and also forms a seal around the cable assembly 240. Additional support is provided to the cable assembly 240 by the initial over-mold. A second vent 674 allows air to escape the second mold cavity 662 and also prevents excess pressure from developing within the cavity 662.

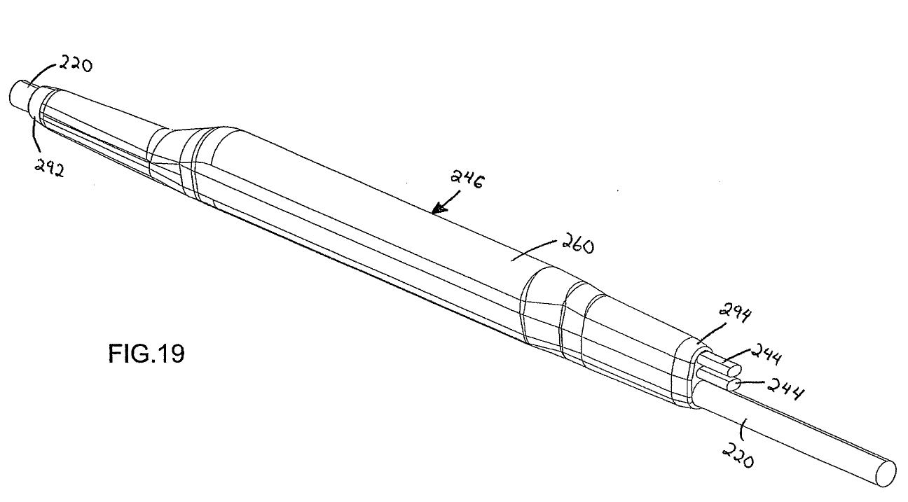

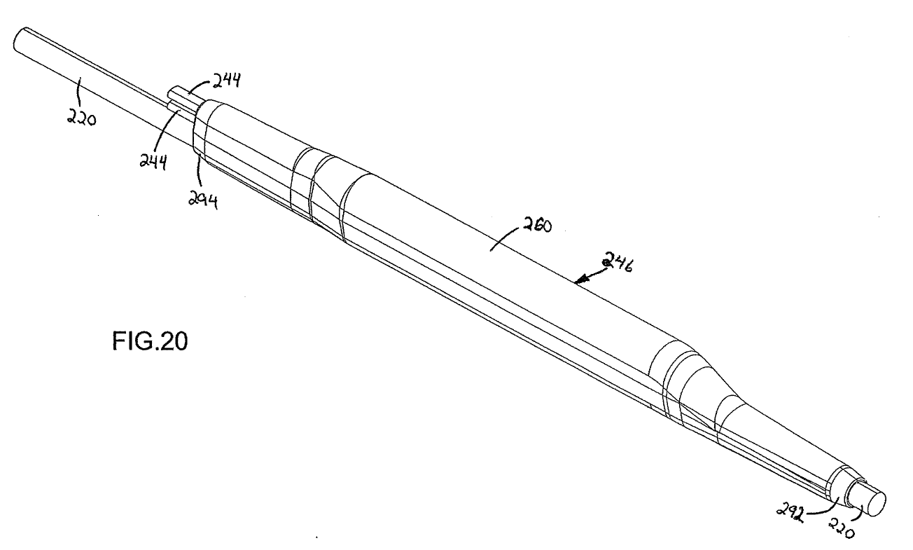

The second mold cavity 662 is injected with additional molten molding material combining with the initial over-mold to create a final over-mold 260. Excess molding material can exit through the second vent 674. The additional molten molding material can fuse with the initial over-mold. The final over-mold 260 is allowed to cool until it is sufficiently solid. The mold 645 is then removed from the cable system 240 as shown at FIGS. 19 and 20.

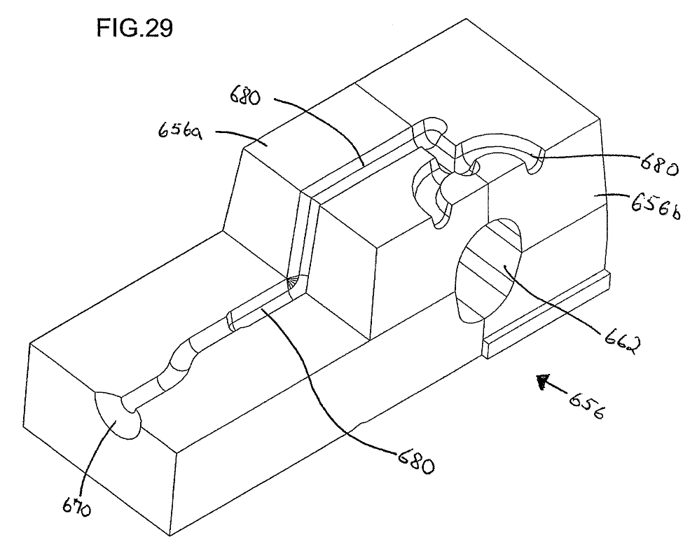

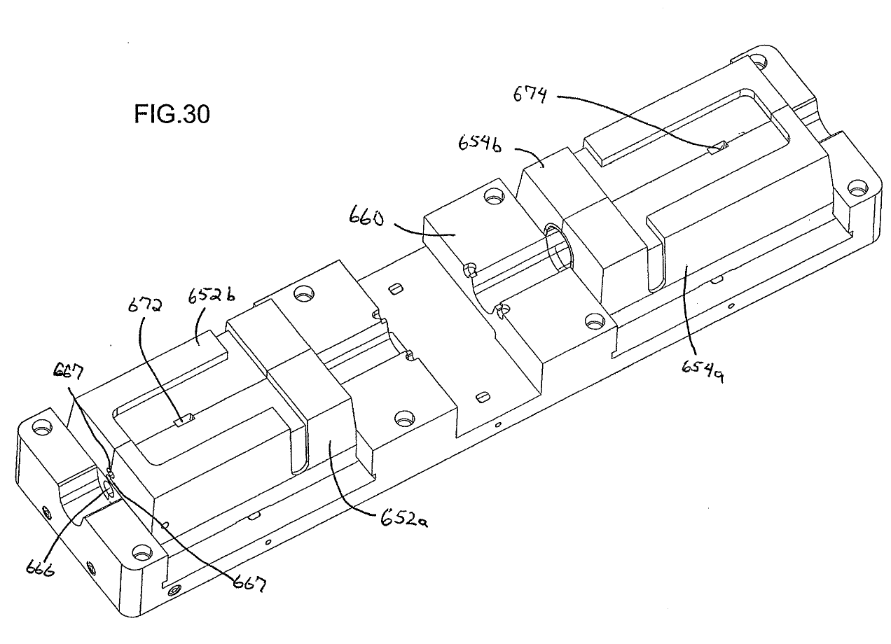

To facilitate installation of the fiber optic cable assembly 240, the various mold sections are separable. For example, the top mold section 658 and bottom mold section 660 are mating halves. The first mold section 652 is formed from a first half 652a and a second half 652b. Likewise, the second mold section 654 is formed from a first half 654a and a second half 654b. As illustrated at FIG. 28, the initial center mold section 656′ is formed from a first half 656a′ and a second half 656b′ split vertically. Likewise, the final center mold section 656 is formed from a first half 656a and a second half 656b, as illustrated at FIG. 29.

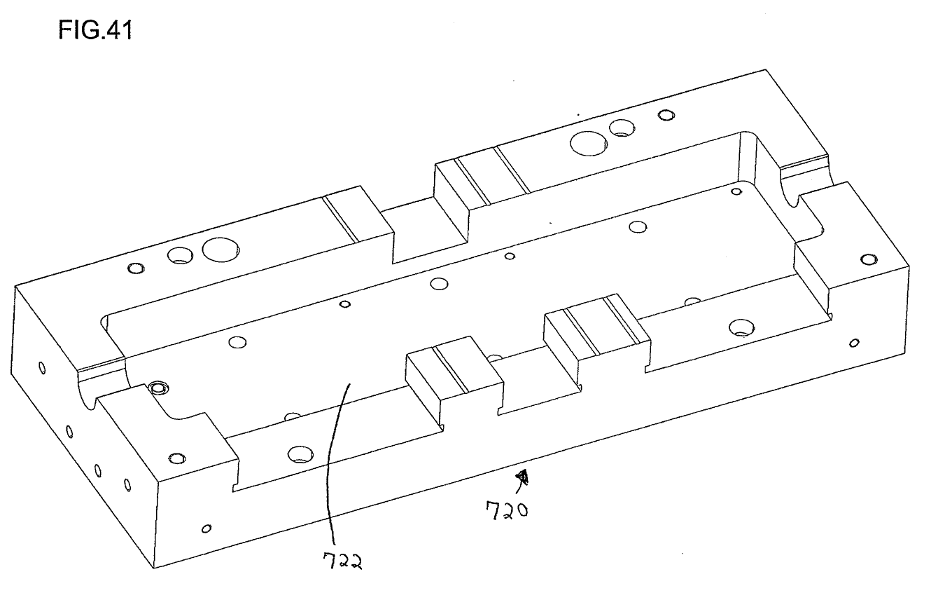

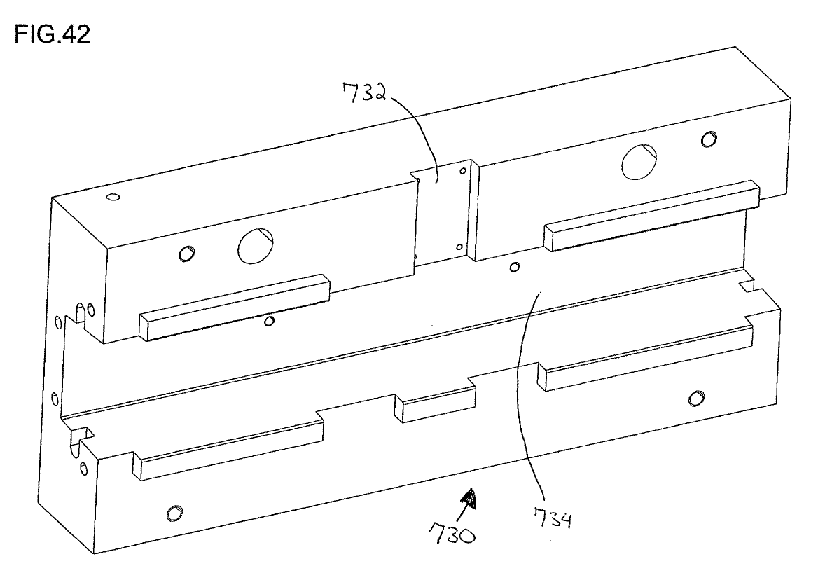

Additional example tools such as an inlet block 710, illustrated at FIG. 40, a mold press base 720, illustrated at FIG. 41, and a mold press top 730, illustrated at FIG. 42, facilitate installing the mold 645 in an injection molding machine. The mold press base 720 includes a pocket 722 for holding the bottom of the mold 645. Similarly, the mold press top 730 includes a channel 734 for holding the top of the mold 645. The mold press top 730 further includes an inlet block channel 732 for receiving the inlet block 710.

In addition to the cable and cable assemblies disclosed above, the concepts of the present disclosure may be applied to other cable systems, both optical and non-optical. An example of another cable assembly is given at U.S. Provisional Patent Application Ser. No. 60/976,054, filed Sep. 28, 2007, and U.S. patent application Ser. No. 12/180,670, filed Jul. 28, 2008, both entitled FACTORY SPLICED CABLE ASSEMBLY, which are hereby incorporated by reference in their entirety.

From the forgoing detailed description, it will be evident that modifications and variations can be made without departing from the spirit or scope of the invention.

What is claimed is:

1. A cable over-molding system including a first configuration and a second configuration for applying an over-mold to a cable assembly, the cable over-molding system comprising:
a first set of mold tools including at least a first mold tool and a second mold tool, the first set of mold tools defining a first cavity and a first inlet passage, the first inlet passage connecting the first cavity to an injection inlet, the first cavity defining a first volume, the first set of mold tools defining a first cable port and a second cable port; and
a second set of mold tools including at least a third mold tool and a fourth mold tool, the second set of mold tools defining a second cavity and a second inlet passage, a portion of the second cavity enveloping the first volume, another portion of the second cavity not enveloped by the first volume defining a second volume, the second inlet passage connecting the second volume of the second cavity to the injection inlet, the second set of mold tools defining a third cable port;
wherein the cable assembly includes a cable, the cable extending at least between a first cable position and a second cable position and between the second cable position and a third cable position;
wherein the cable is held at the first cable position by the first cable port of the first set of mold tools and at the second cable position by the second cable port of the first set of mold tools when the cable over-molding system is arranged in the first configuration;
wherein the cable is held at the third cable position by the third cable port of the second set of mold tools when the cable over-molding system is arranged in the second configuration;
wherein the first volume of the first cavity encloses a first portion of the cable assembly between the first cable position and the second cable position when the cable over-molding system is in the first configuration; and
wherein the second volume of the second cavity encloses a second portion of the cable assembly between the first volume and the third cable position when the cable over-molding system is in the second configuration.

2. The cable over-molding system of claim 1, wherein the cable is a fiber optic cable.

3. The cable over-molding system of claim 1, wherein the first set of mold tools further includes a fifth mold tool and a sixth mold tool, the first cable port formed on and between the first and the second mold tools and the second cable port formed on and between the fifth and the sixth mold tools, wherein the first cable port holds the first cable position when the first and the second mold tools are closed and abut each other and the first cable position is released from the first cable port when the first and the second mold tools are opened from each other, wherein the second cable port holds the second cable position when the fifth and the sixth mold tools are closed and abut each other and the second cable position is released from the second cable port when the fifth and the sixth mold tools are opened from each other, and wherein the first inlet passage is at least partly defined by the fifth and the sixth mold tools.

4. The cable over-molding system of claim 3, wherein the cable assembly further includes a tether cable, wherein a tether cable port is formed on and between the first and the second mold tools, and wherein the tether cable port holds the tether cable when the first and the second mold tools are closed and abut each other and the tether cable is released from the tether cable port when the first and the second mold tools are opened from each other.

5. The cable over-molding system of claim 3, wherein the second set of mold tools further includes a seventh mold tool and an eighth mold tool, the third cable port formed on and between the third and the fourth mold tools, wherein the third cable port holds the third cable position when the third and the fourth mold tools are closed and abut each other and the third cable position is released from the third cable port when the third and the fourth mold tools are opened from each other, and wherein the second inlet passage is at least partly defined by the seventh and the eighth mold tools.

6. The cable over-molding system of claim 5, wherein the first, the second, the fifth, and the sixth mold tools are used when the cable over-molding system is arranged in the first configuration.

7. The cable over-molding system of claim 6, wherein the third and the fourth mold tools are also used when the cable over-molding system is arranged in the first configuration.

8. The cable over-molding system of claim 5, wherein the third, the fourth, the seventh, and the eighth mold tools are used when the cable over-molding system is arranged in the second configuration.

9. The cable over-molding system of claim 8, wherein the first and the second mold tools are also used when the cable over-molding system is arranged in the second configuration.

10. A method of over-molding an over-mold onto a fiber optic cable assembly, the method comprising:
providing a first mold tool set including a first cavity and first and second ports;
positioning the first mold tool set around a first portion of the fiber optic cable assembly and holding the fiber optic cable assembly at the first and the second ports;
injecting a molding material into the first cavity of the first mold tool set and thereby over-molding the first portion of the fiber optic cable assembly with a first over-mold;
providing a second mold tool set including a second cavity and a third port;
positioning the second mold tool set around the first portion and a second portion of the fiber optic cable assembly, holding the fiber optic cable assembly at the third port, and holding the first over-mold within a portion of second cavity;
injecting additional molding material into the second cavity of the second mold tool set and thereby over-molding the second portion of the fiber optic cable assembly with a second over-mold, the second over-mold abutting the first over-mold.
